(19) United States
(12) Patent Application Publication
(10) Pub. No.: US 2025/0254011 A1
(43) Pub. Date: Aug. 7, 2025

(54) METHOD AND APPARATUS FOR WIRELESS COMMUNICATION

(71) Applicant: LENOVO (BEIJING) LIMITED, Beijing (CN)

(72) Inventors: Lianhai Wu, Beijing (CN); Congchi Zhang, Shanghai (CN); Ran Yue, Beijing (CN); Jing Han, Beijing (CN); Haiming Wang, Beijing (CN)

(21) Appl. No.: 18/856,204

(22) PCT Filed: Apr. 12, 2022
(86) PCT No.: PCT/CN2022/086316

§ 371 Date: Oct. 11, 2024

(51) Int. Cl. H04L 5/00; H04W 36/00; H04W 88/04

(52) U.S. Cl. CPC H04L 5/0092; H04W 36/0009; H04W 88/04

(57) ABSTRACT

Embodiments of the present disclosure relate to methods and apparatuses for wireless communications in a communication system. According to some embodiments of the disclosure, a UE may: communicate with a BS via a relay node; and receive, via the relay node from the BS, an RRC reconfiguration message for path switch, wherein the RRC reconfiguration message for path switch indicates that the UE and the relay node are switched together.

### TECHNICAL FIELD

Embodiments of the present disclosure generally relate to communication technology, and more particularly to wireless communications in a communication system.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

Some wireless communication systems may support sidelink communications, in which devices (e.g., UEs) that are relatively close to each other may communicate with one another directly via a sidelink, rather than being linked through the BS. A relaying function based on a sidelink may be supported in a communication network. For example, a UE supporting sidelink communication may function as a relay node to extend the coverage of a BS. An out-of-coverage or in-coverage UE may communicate with a BS via a relay node (e.g., a relay UE). In the context of the present disclosure, a UE, which functions as a relay between another UE and a BS, may be referred to as a UE-to-network (U2N) relay.

There is a need for efficiently performing communication in a communication system supporting a U2N relay.

### SUMMARY

Some embodiments of the present disclosure provide a user equipment (UE). The UE may include: a transceiver; and a processor coupled to the transceiver. The processor may be configured to: communicate with a base station (BS) via a relay node; and receive, via the relay node from the BS, a radio resource control (RRC) reconfiguration message for path switch, wherein the RRC reconfiguration message for path switch may indicate that the UE and the relay node are switched together.

Some embodiments of the present disclosure provide a relay node. The relay node may include: a transceiver; and a processor coupled to the transceiver. The processor may be configured to: establish a communication link between a user equipment (UE) and the relay node, wherein the UE communicates with a base station (BS) via the relay node; and receive, from the BS, a radio resource control (RRC) reconfiguration message for handover, wherein the RRC reconfiguration message for handover may indicate that the UE and the relay node are switched together.

In some embodiments, the RRC reconfiguration message for handover may indicate at least one remote UE including the UE.

In some embodiments, the RRC reconfiguration message for handover may indicate an ID of a remote UE, which is a source layer-2 ID of the UE.

In some embodiments, the processor may be configured to transmit a first indication to the UE in response to a successful handover of the relay node, an unsuccessful handover of the relay node, or reestablishment of the relay node.

In some embodiments, the RRC reconfiguration message for handover encapsulates an RRC reconfiguration message for path switch associated with the UE.

In some embodiments, the processor may be configured to transmit a second indication indicating an upcoming path switch to the UE in response to receiving the RRC reconfiguration message for handover. In some embodiments, the second indication may indicate a value of a timer for the upcoming path switch.

In some embodiments, the RRC reconfiguration message for handover may indicate a value of a timer for an upcoming path switch.

In some embodiments, the processor may be configured to transmit the RRC reconfiguration message for path switch to the UE in response to a successful random access of the relay node. In some other embodiments, the processor may be configured to transmit, to the UE, the RRC reconfiguration message for path switch and a third indication which may indicate a successful handover of the relay node in response to a successful random access of the relay node.

In some embodiments, the RRC reconfiguration message for path switch may indicate that the UE and the relay node are switched together.

In some embodiments, in response to receiving the RRC reconfiguration message for handover, the processor may be configured to perform at least one of: reestablishing a radio link control (RLC) entity of the relay node when a bearer between the UE and the relay node may be configured to reestablish the RLC entity; or reestablishing a packet data convergence protocol (PDCP) entity of the relay node when the bearer between the UE and the relay node is configured to reestablish the PDCP entity.

Some embodiments of the present disclosure provide a BS. The BS may include: a transceiver; and a processor coupled to the transceiver. The processor may be configured to: receive a handover request message from a first BS, wherein the handover request message may indicate a UE and a relay node are switched together and wherein the UE communicates with the first BS via the relay node; and transmit a handover request acknowledgement message to the first BS in response to the handover request message.

In some embodiments, the handover request acknowledgement message may include a radio resource control (RRC) reconfiguration message for path switch associated with the UE, and an RRC reconfiguration message for handover associated with the relay node. The RRC reconfiguration message for path switch associated with the UE and the RRC reconfiguration message for handover associated with the relay node may indicate that the UE and the relay node are switched together.

In some embodiments, the RRC reconfiguration message for path switch associated with the UE may indicate the relay node as a target relay node for the path switch; and wherein the RRC reconfiguration message for handover associated with the relay node may indicate at least one remote UE including the UE.

In some embodiments, the RRC reconfiguration message for path switch associated with the UE may indicate an ID of a target relay node for the path switch, which is a source layer-2 ID of the relay node; and the RRC reconfiguration message for handover associated with the relay node may indicate an ID of a remote UE, which is a source layer-2 ID of the UE.

In some embodiments, the RRC reconfiguration message for path switch associated with the UE and the RRC reconfiguration message for handover associated with the relay node are independently included in the same handover request acknowledgement message or included in separate handover request acknowledgement messages.

In some embodiments, the RRC reconfiguration message for path switch associated with the UE may indicate a value of a timer for group-based path switch.

In some embodiments, the RRC reconfiguration message for path switch associated with the UE is encapsulated in the RRC reconfiguration message for handover associated with the relay node. In some embodiments, the RRC reconfiguration message for handover associated with the relay node may indicate a value of a timer for an upcoming path switch.

Some embodiments of the present disclosure provide a method performed by a user equipment (UE). The method may include: communicating with a base station (BS) via a relay node; and receiving, via the relay node from the BS, a radio resource control (RRC) reconfiguration message for path switch, wherein the RRC reconfiguration message for path switch may indicate that the UE and the relay node are switched together.

Some embodiments of the present disclosure provide a method performed by a relay node. The method may include: establishing a communication link between a user equipment (UE) and the relay node, wherein the UE communicates with a base station (BS) via the relay node; and receiving, from the BS, a radio resource control (RRC) reconfiguration message for handover, wherein the RRC reconfiguration message for handover may indicate that the UE and the relay node are switched together.

Some embodiments of the present disclosure provide a method performed by a BS. The method may include: receiving a handover request message from a first BS, wherein the handover request message may indicate a UE and a relay node are switched together and wherein the UE communicates with the first BS via the relay node; and transmitting a handover request acknowledgement message to the first BS in response to the handover request message.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions to facilitate and improve the implementation of various communication technologies, such as 5G NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a schematic diagram of a relay based wireless communication system in accordance with some embodiments of the present disclosure;

FIGS. 3 and 4 illustrate a flow chart of an exemplary procedure for group-based path switch in accordance with some embodiments of the present disclosure;

FIGS. 5-7 illustrate a flow chart of an exemplary procedure of wireless communications in accordance with some embodiments of the present disclosure; and

FIG. 8 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architectures and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

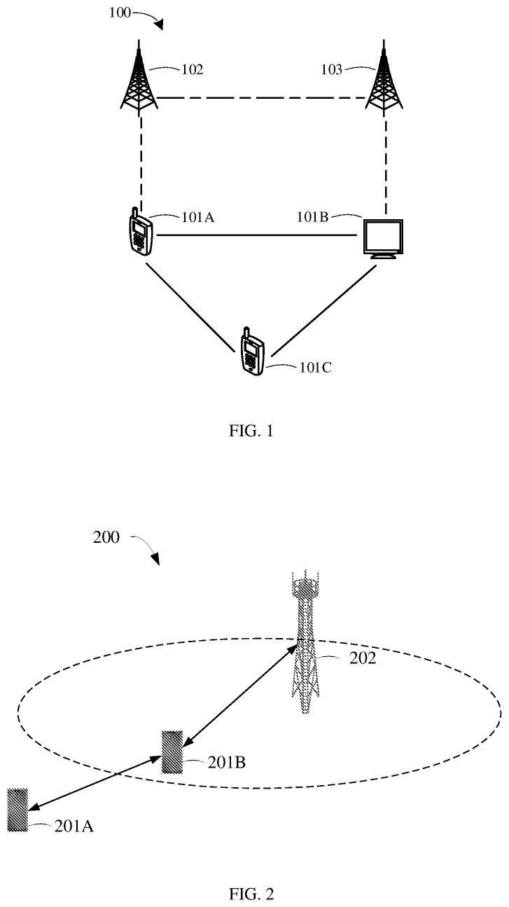

FIG. 1 illustrates a schematic diagram of wireless communication system 100 in accordance with some embodiments of the present disclosure.

As shown in FIG. 1, the wireless communication system 100 may support sidelink communications. Sidelink communication supports UE-to-UE direct communication. Two sidelink resource allocation modes may be supported (e.g., denoted as mode 1 and mode 2). In mode 1, the sidelink resource is scheduled by a BS. In mode 2, a UE decides the sidelink transmission resources and timing in a resource pool based on a measurement result(s) and sensing result(s).

In the context of the present disclosure, sidelink communications may be categorized according to the wireless communication technologies adopted. For example, sidelink communication may include NR sidelink communication and V2X sidelink communication. NR sidelink communications (e.g., specified in 3GPP specification TS 38.311) may refer to access stratum (AS) functionality enabling at least vehicle-to-everything (V2X) communications as defined in 3GPP specification TS 23.287 between neighboring UEs, using NR technology but not traversing any network node. V2X sidelink communications (e.g., specified in 3GPP specification TS 36.311) may refer to AS functionality enabling V2X communications as defined in 3GPP specification TS 23.285 between neighboring UEs, using evolved-universal mobile telecommunication system (UMTS) terrestrial radio access (UTRA) (E-UTRA) technology, but not traversing any network node. However, if not being specified, “sidelink communications” may refer to NR sidelink communications, V2X sidelink communications, or any sidelink communications adopting other wireless communication technologies.

Referring to FIG. 1, the wireless communication system 100 may include some base stations (e.g., BS 102 and BS 103) and some UEs (e.g., UE 101A, UE 101B, and UE 101C). Although a specific number of UEs and BSs is depicted in FIG. 1, it is contemplated that any number of UEs and BSs may be included in the wireless communication system 100.

The UEs and the BSs may support communication based on, for example, 3G, long-term evolution (LTE), LTE-advanced (LTE-A), new radio (NR), or other suitable protocol(s). In some embodiments of the present disclosure, a BS (e.g., BS 102 or BS 103) may be referred to as an access point, an access terminal, a base, a base unit, a macro cell, a Node-B, an evolved Node B (eNB), a gNB, an ng-eNB, a Home Node-B, a relay node, or a device, or described using other terminology used in the art. A UE (e.g., UE 101A, UE 101B, or UE 101C) may include, for example, but is not limited to, a computing device, a wearable device, a mobile device, an IoT device, a vehicle, etc. Persons skilled in the art should understand that as technology develops and advances, the terminologies described in the present disclosure may change, but should not affect or limit the principles and spirit of the present disclosure.

In the example of FIG. 1, the BS 102 and the BS 103 may be included in a next generation radio access network (NG-RAN). In some embodiments of the present disclosure, the BS 102 may be a gNB and the BS 103 may be an ng-eNB.

The UE 101A and UE 101B may be in-coverage (e.g., inside the NG-RAN). For example, as shown in FIG. 1, the UE 101A may be within the coverage of BS 102, and the UE 101B may be within the coverage of BS 103. The UE 101C may be out-of-coverage (e.g., outside the coverage of the NG-RAN). For example, as shown in FIG. 1, the UE 101C may be outside the coverage of any BS, for example, both the BS 102 and BS 103. The UE 101A and UE 101B may respectively connect to the BS 102 and BS 103 via a network interface, for example, the Uu interface as specified in 3GPP standard documents. The control plane protocol stack in the Uu interface may include a radio resource control (RRC) layer, which may be referred to as a Uu RRC. The link established between a UE (e.g., UE 101A) and a BS (e.g., BS 102) may be referred to as a Uu link. The BS 102 and BS 103 may be connected to each other via a network interface, for example, the Xn interface as specified in 3GPP standard documents. The UE 101A, UE 101B, and UE 101C may be connected to each other respectively via, for example, a PC5 interface as specified in 3GPP standard documents. The control plane protocol stack in the PC5 interface may include a radio resource control (RRC) layer, which may be referred to as a PC5 RRC. The link established between two UEs (e.g., UE 101A and UE 101B) may be referred to as a PC5 link.

Support for V2X services via the PC5 interface can be provided by, for example, NR sidelink communication and/or V2X sidelink communication. NR sidelink communication can support one of the following three types of transmission modes for a pair of a source Layer-2 identity and a destination Layer-2 identity: unicast transmission, groupcast transmission, and broadcast transmission. Sidelink communication transmission and reception over the PC5 interface are supported when the UE is either in-coverage or out-of-coverage. For example, the UE 101A, which is within the coverage of the BS 102, can perform sidelink transmission and reception (e.g., sidelink unicast transmission, sidelink groupcast transmission, or sidelink broadcast transmission) over a PC5 interface. The UE 101C, which is outside the coverage of both the BS 102 and BS 103, can also perform sidelink transmission and reception over a PC5 interface.

A UE which supports sidelink communication and/or V2X communication may be referred to as a V2X UE. A V2X UE may be a cell phone, a vehicle, a roadmap device, a computer, a laptop, an IoT (internet of things) device or other type of device in accordance with some other embodiments of the present disclosure.

As mentioned above, the relaying function based on a sidelink may be supported in a communication network. In some embodiments of the present disclosure, a UE-to-network relay is supported. For example, an in-coverage UE in communication with a remote UE (e.g., an out-of-coverage UE or in-coverage UE) may function as a relay UE between the serving BS of the in-coverage UE and the remote UE. The remote UE may thus communicate with the BS via this relay UE. The data between the remote UE and the BS may be transferred by the relay UE. In this scenario, the relay UE may be referred to as a serving relay of the remote UE, and the serving BS or serving cell of the relay UE may be referred to as the serving BS or serving cell of the remote UE.

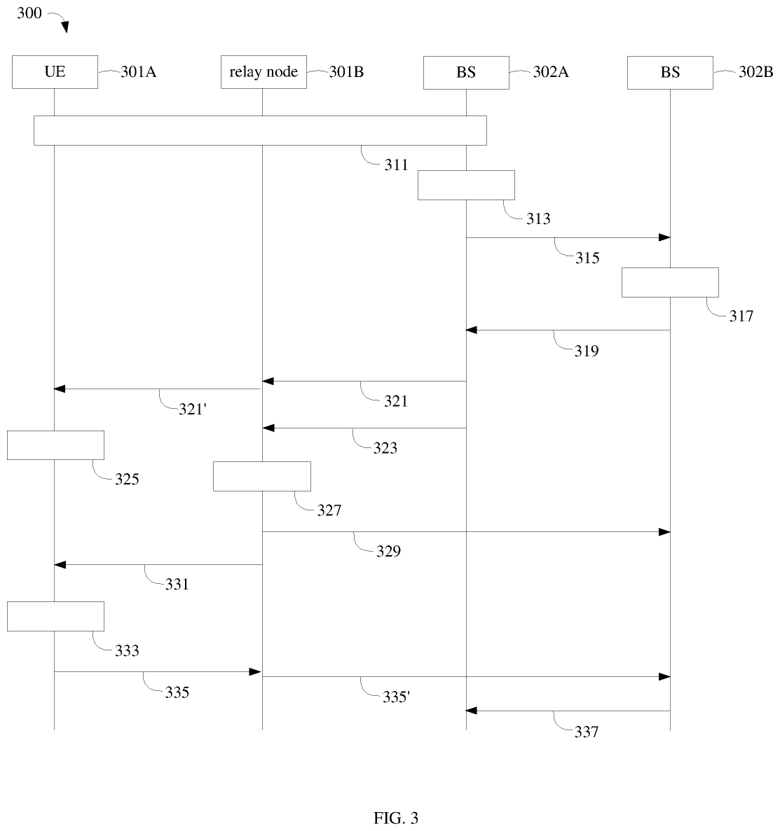

FIG. 2 illustrates a schematic diagram of a relay based wireless communication system 200 in accordance with some embodiments of the present disclosure. Details described in all of the foregoing embodiments of the present disclosure are applicable for the embodiments shown in FIG. 2.

As shown in FIG. 2, the wireless communication system 200 may include a BS (e.g., BS 202) and some UEs (e.g., UE 201A and UE 201B). Although a specific number of UEs and BS is depicted in FIG. 2, it is contemplated that any number of UEs and BSs may be included in the wireless communication system 200. In some examples, UE 201B may function as UE 101A or UE 101B shown in FIG. 1, and UE 201A may function as UE 101C shown in FIG. 1.

UE 201B may be within the coverage of BS 202. For example, UE 201B and BS 202 may establish an RRC connection therebetween. UE 201A may be outside of the coverage of BS 202. The wireless communication system 200 may support sidelink communications. For example, UE 201B may be in sidelink communication with UE 201A. A PC5 RRC connection may be established between UE 201A and UE 201B.

In some embodiments of the present disclosure, UE 201A may initiate a procedure for establishing a connection with BS 202 via UE 201B (i.e., UE-to-network relay). For example, UE 201A may transmit an RRC setup request to BS 202 via UE 201B. BS 202 may transmit an RRC setup message including a response to UE 201A via UE 201B. After such procedure, UE 201A may access BS 202 (e.g., a cell of BS 202) via UE 201B. This cell may be referred to as a serving cell of UE 201A. UE 201A and BS 202 may establish an RRC connection therebetween. UE 201A may have RRC states, such as an RRC_IDLE state, an RRC_INACTIVE state, and an RRC_CONNECTED state. UE 201A may also be referred to as a remote UE and UE 201B may also be referred to as a relay UE or a serving relay of UE 201A.

It should be appreciated by persons skilled in the art that although a single relay node (e.g., UE 201B) between UE 201A and BS 202 is depicted in FIG. 2, it is contemplated that any number of relay nodes may be included. Although it is shown in FIG. 2 that UE 201A is outside of the coverage of BS 202, it is contemplated that UE 201A may be within the coverage of BS 202 in some other embodiments of the present disclosure. In these embodiments, UE 201A may directly connect to BS 202 and/or connect to BS 202 via UE 201B.

Under certain circumstances, a BS (source BS) may hand over both a remote UE and a relay node (e.g., the remote UE connects to the BS via the relay node) to another BS (target BS). For example, after a successful handover, the UE may communicate with the target BS via the relay node. This may also be referred to as “group-based path switch.” The relay node may be a relay UE. Embodiments of the present disclosure provide solutions for performing such handover.

Various issues need to be solved during such handover process. For example, whether the group-based path switch is supported in a U2N network, whether the remote UE performs the path switch to the target BS before or after the relay node performs handover and what are the corresponding impacts, how to indicate the group-based path switch, what is the behavior of the remote UE when the remote UE receives the reconfiguration message for path switch, what is the possible impact on the Xn interface, what is the behavior of the relay node when the relay node receives the reconfiguration message for handover, how to handle the radio link control (RLC) entity and packet data convergence protocol (PDCP) entity in the relay node and remote UE, and so on. Solutions are proposed to solve at least the above-mentioned issues. More details on the embodiments of the present disclosure will be illustrated in the following text in combination with the appended drawings.

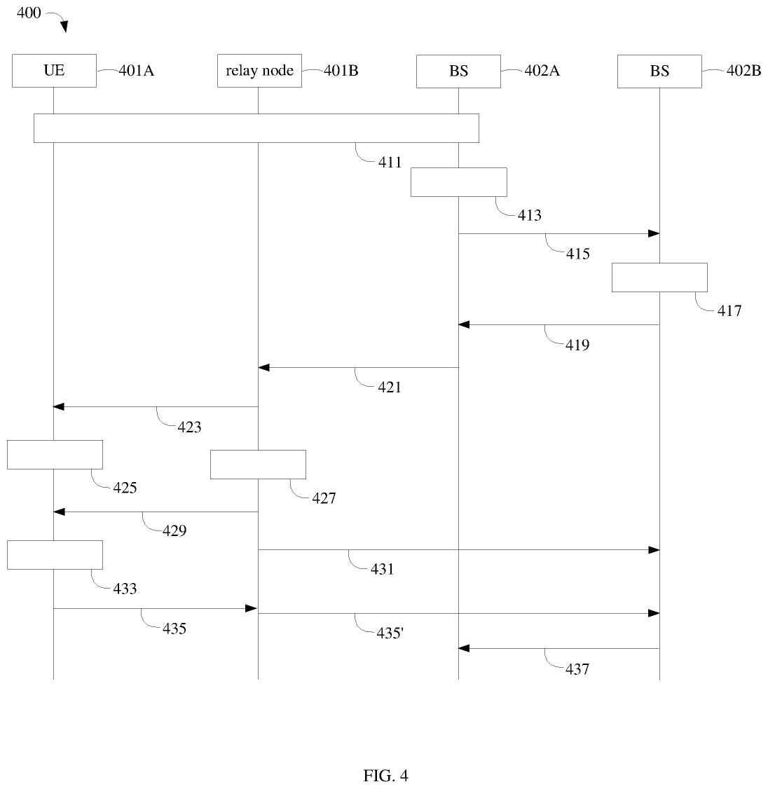

In some embodiments, in the case of group-based path switch, a remote UE may receive a reconfiguration message for path switch from the source cell via a relay node before the relay node performs a handover. FIG. 3 illustrates a flow chart of exemplary procedure 300 for group-based path switch in accordance with some embodiments of the present disclosure. Details described in all of the foregoing embodiments of the present disclosure are applicable for the embodiments shown in FIG. 3.

Referring to FIG. 3, in operation 311, UE 301A may access BS 302A via relay node 301B. In some embodiments, relay node 301B may be a UE. Relay node 301B may report measurement results to BS 302A via a Uu interface based on a configuration. In some embodiments, relay node 301B may report whether group-based path switch is supported or not at relay node 301B. UE 301A may stay in a connected state. UE 301A may report measurement results to BS 302A via relay node 301B based on a configuration. In some embodiments, UE 301A may report whether group-based path switch is supported or not at UE 301A.

In operation 313, BS 302A may determine to switch both UE 301A and relay node 301B to the same target cell (e.g., a cell of BS 302B). In some embodiments, BS 302A may determine whether to perform such group-based path switch based on the capability (e.g., whether group-based path switch is supported or not) of UE 301A and relay node 301B. UE 301A may continue to connect to relay node 301B.

In operation 315, BS 302A may transmit a handover request message to BS 302B. BS 302A and BS 302B may be referred to the “source BS” and “target BS,” respectively. The handover request message may include information associated with UE 301A and information associated with relay node 301B. Such information may include an AS configuration (e.g., AS-config) and AS context (e.g., AS-context) associated with UE 301A and relay node 301B, and capability information of UE 301A and relay node 301B. In some embodiments, the handover request message may indicate that UE 301A and relay node 301B are switched together. For example, the handover request message may include an indication to indicate a group-based path switch.

In operation 317, BS 302B may perform admission control for the path switch. In operation 319, BS 302B may transmit a handover request acknowledge message(s) to BS 302A in response to the handover request message. The handover request acknowledge message(s) may include an RRC reconfiguration message for path switch associated with UE 301A and an RRC reconfiguration message for handover associated with relay node 301B. In some examples, the RRC reconfiguration message for path switch associated with UE 301A and the RRC reconfiguration message for handover associated with relay node 301B may be included in the same handover request acknowledgement message. In some examples, the RRC reconfiguration message for path switch associated with UE 301A and the RRC reconfiguration message for handover associated with relay node 301B may be included in separate handover request acknowledgement messages.

In some embodiments, the RRC reconfiguration message for path switch associated with UE 301A and the RRC reconfiguration message for handover associated with relay node 301B may indicate that UE 301A and relay node 301B are switched together.

For example, the RRC reconfiguration message for path switch associated with UE 301A may indicate at least one target relay UE for the path switch. In some embodiments, the RRC reconfiguration message for path switch associated with UE 301A may indicate relay node 301B as a target relay node for the path switch. For example, the RRC reconfiguration message for path switch associated with UE 301A may indicate an ID of a target relay node for the path switch, which is a source layer-2 ID of relay node 301B. In this way, the group-based path switch is implicitly indicated.

In some embodiments, the RRC reconfiguration message for path switch associated with UE 301A may indicate the value of a timer for group-based path switch.

For example, the RRC reconfiguration message for handover associated with relay node 301B may indicate at least one remote UE to be switched together. In some embodiments, the at least one remote UE may include UE 301A. For example, the RRC reconfiguration message for handover associated with relay node 301B may indicate an ID of a remote UE, which is a source layer-2 ID of UE 301A. In this way, the group-based path switch is implicitly indicated.

In operations 321 and 321′, BS 302A may transmit the RRC reconfiguration message for path switch associated with UE 301A to UE 301A via relay node 301B. In response to receiving the RRC reconfiguration message, UE 301A may, in operation 325, determine that a group-based path switch is configured. For example, the RRC reconfiguration message may indicate that UE 301A and relay node 301B are switched together by, for example, indicating a target relay node with the same ID (e.g., source layer-2 ID) as that of relay node 301B. For example, the RRC reconfiguration message may indicate a target relay node ID, which is the source layer-2 ID of relay node 301B.

In some embodiments, in response to receiving the RRC reconfiguration message which indicates that UE 301A and relay node 301B are switched together, UE 301A may store the RRC reconfiguration message and may apply the RRC reconfiguration message later. For example, as will be described in the following text, UE 301A may apply the RRC reconfiguration message in response to receiving an indication from relay node 301B. The indication may indicate a successful handover of relay node 301B, an unsuccessful handover of relay node 301B, or a reestablishment of relay node 301B.

In some embodiments, in response to receiving the RRC reconfiguration message which indicates that UE 301A and relay node 301B are switched together, UE 301A may start a timer for group-based path switch. In some examples, the value of the timer may be indicated in the RRC reconfiguration message or another message. In some examples, the value of the timer may be predefined in, for example, a standard(s).

In some embodiments, UE 301A may stop transmitting user plane (UP) data when the timer for group-based path switch is running. In some embodiments, UE 301A may perform reestablishment in response to the expiry of the timer for group-based path switch. In some embodiments, as will be described in the following text, UE 301A may stop the timer for group-based path switch in response to receiving an indication from relay node 301B. The indication may indicate a successful handover of relay node 301B, an unsuccessful handover of relay node 301B, or a reestablishment of relay node 301B.

In some embodiments, in response to receiving the RRC reconfiguration message, UE 301A may reestablish its RLC entity when the bearer between UE 301A and relay node 301B is configured to reestablish the RLC entity. In some embodiments, in response to receiving the RRC reconfiguration message, UE 301A may reestablish its PDCP entity when the bearer between UE 301A and relay node 301B is configured to reestablish the PDCP entity.

In operation 323, BS 302A may transmit the RRC reconfiguration message for handover associated with relay node 301B to relay node 301B. For example, BS 302A may transmit the RRC reconfiguration message for handover to relay node 301B after UE 301A successfully receives the reconfiguration message for path switching. In some other embodiments of the present disclosure, operation 323 may occur before operations 321 and 321′.

In response to receiving the RRC reconfiguration message, relay node 301B may determine that a group-based path switch is configured. For example, the RRC reconfiguration message may indicate that UE 301A and relay node 301B are switched together by, for example, indicating a remote UE ID, which is the ID (e.g., source layer-2 ID) of UE 301A.

In some embodiments, in response to receiving the RRC reconfiguration message, relay node 301B may reestablish its RLC entity when the bearer between UE 301A and relay node 301B is configured to reestablish the RLC entity. In some embodiments, in response to receiving the RRC reconfiguration message, relay node 301B may reestablish its PDCP entity when the bearer between UE 301A and relay node 301B is configured to reestablish the PDCP entity.

In response to receiving the RRC reconfiguration message, relay node 301B may switch to the target cell in operation 327. For example, relay node 301B may perform a random access procedure. In response to a successful random access, relay node 301B may transmit a reconfiguration complete message to BS 302B in operation 329.

In some embodiments, in response to a successful handover of relay node 301B (e.g., in response to the successful random access, the transmission of the reconfiguration complete message, or the like), relay node 301B may transmit an indication to UE 301A in operation 331. In some embodiments, UE 301A may stop the timer for group-based path switch (if running) in response to receiving the indication indicating the successful handover.

In some embodiments, UE 301A may, in operation 333, apply the stored RRC reconfiguration message for path switch associated with UE 301A in response to receiving the indication indicating the successful handover. For example, UE 301A may switch to the target cell (e.g., via relay node 301B). In operations 335 and 335′, UE 301A may transmit a reconfiguration complete message to BS 302B via relay 301B in response to a successful path switch.

In operation 337, BS 302B may transmit to BS 302A a UE context release message for relay node 301B, UE 301A, or both. For example, in response to receiving the reconfiguration complete messages from relay node 301B and UE 301A, BS 302B may indicate to release the UE context of both relay node 301B and UE 301A.

In some other embodiments of the present disclosure, the handover of relay node 301B may fail. Relay node 301B may perform reestablishment in response to the handover failure. In some embodiments, relay node 301B may transmit an indication to UE 301A to indicate the unsuccessful handover or reestablishment. In some embodiments, in response to receiving the indication indicating the unsuccessful handover or reestablishment, UE 301A may stop the timer for group-based path switch (if running). In some embodiments, in response to receiving the indication indicating the unsuccessful handover or reestablishment, UE 301A may apply the stored RRC reconfiguration message for path switch associated with UE 301A or perform reestablishment.

It should be appreciated by persons skilled in the art that the sequence of the operations in exemplary procedure 300 may be changed and that some of the operations in exemplary procedure 300 may be eliminated or modified, without departing from the spirit and scope of the disclosure.

In some embodiments, in the case of group-based path switch, a remote UE may receive a reconfiguration message for path switch from the relay node after the relay node performs a handover. FIG. 4 illustrates a flow chart of exemplary procedure 400 for group-based path switch in accordance with some embodiments of the present disclosure. Details described in all of the foregoing embodiments of the present disclosure are applicable for the embodiments shown in FIG. 4.

Referring to FIG. 4, in operation 411, UE 401A may access BS 402A via relay node 401B. In some embodiments, relay node 401B may be a UE. Relay node 401B may report measurement results to BS 402A via a Uu interface based on a configuration. In some embodiments, relay node 401B may report whether group-based path switch is supported or not at relay node 401B. UE 401A may stay in a connected state. UE 401A may report measurement results to BS 402A via relay node 401B based on a configuration. In some embodiments, UE 401A may report whether group-based path switch is supported or not at UE 401A.

In operation 413, BS 402A may determine to switch both UE 401A and relay node 401B to the same target cell (e.g., a cell of BS 402B). In some embodiments, BS 402A may determine whether to perform such group-based path switch based on the capability (e.g., whether group-based path switch is supported or not) of UE 401A and relay node 401B. UE 401A may continue to connect to relay node 401B.

In operation 415, BS 402A may transmit a handover request message to BS 402B. BS 402A and BS 402B may be referred to the “source BS” and “target BS,” respectively. The handover request message may include information associated with UE 401A and information associated with relay node 401B. Such information may include an AS configuration (e.g., AS-config) and AS context (e.g., AS-context) associated with UE 401A and relay node 401B, and capability information of UE 401A and relay node 401B. In some embodiments, the handover request message may indicate that UE 401A and relay node 401B are switched together. For example, the handover request message may include an indication to indicate a group-based path switch.

In operation 417, BS 402B may perform admission control for the path switch. In operation 419, BS 402B may transmit a handover request acknowledge message to BS 402A in response to the handover request message.

The handover request acknowledge message may include an RRC reconfiguration message for path switch associated with UE 401A and an RRC reconfiguration message for handover associated with relay node 401B. The RRC reconfiguration message for path switch associated with UE 401A and the RRC reconfiguration message for handover associated with relay node 401B may be included in a single handover request acknowledgement message.

In some embodiments, the RRC reconfiguration message for path switch associated with UE 401A may be encapsulated in the RRC reconfiguration message for handover associated with relay node 401B. For example, the RRC reconfiguration message for path switch associated with UE 401A is contained (e.g., as a container) in the RRC reconfiguration message for handover associated with relay node 401B.

In some embodiments, the RRC reconfiguration message for path switch associated with UE 401A and the RRC reconfiguration message for handover associated with relay node 401B may indicate that UE 401A and relay node 401B are switched together.

For example, the RRC reconfiguration message for path switch associated with UE 401A may indicate at least one target relay UE for the path switch. In some embodiments, the RRC reconfiguration message for path switch associated with UE 401A may indicate relay node 401B as a target relay node for the path switch. For example, the RRC reconfiguration message for path switch associated with UE 401A may indicate an ID of a target relay node for the path switch, which is a source layer-2 ID of relay node 401B.

For example, the RRC reconfiguration message for handover associated with relay node 401B may indicate at least one remote UE to be switched together. In some embodiments, the at least one remote UE may include UE 401A. For example, the RRC reconfiguration message for handover associated with relay node 401B may indicate an ID of a remote UE, which is a source layer-2 ID of UE 401A.

In some embodiments, the RRC reconfiguration message for handover associated with relay node 401B may indicate the value of a timer for an upcoming path switch.

In operation 421, in response to receiving the handover request acknowledge, BS 402A may transmit the RRC reconfiguration message for handover to relay node 401B. The RRC reconfiguration message for handover may include the RRC reconfiguration message for path switch associated with UE 401A.

In operation 423, in response to receiving the RRC reconfiguration message, relay node 401B may transmit an indication indicating an upcoming path switch to UE 401A. In operation 425, UE 401A may start a timer for the upcoming path switch in response to receiving the indication. In some embodiments, the indication may indicate the value of the timer for the upcoming path switch and UE 401A may start the timer based on the indicated timer value. In some embodiments, the timer value may be configured in the RRC reconfiguration message for handover associated with relay node 401B. In some embodiments, UE 401A may perform reestablishment in response to the expiry of the timer.

In some embodiments, in response to receiving the RRC reconfiguration message, relay node 401B may reestablish its RLC entity when the bearer between UE 401A and relay node 401B is configured to reestablish the RLC entity. In some embodiments, in response to receiving the RRC reconfiguration message, relay node 401B may reestablish its PDCP entity when the bearer between UE 401A and relay node 401B is configured to reestablish the PDCP entity.

In response to receiving the RRC reconfiguration message, relay node 401B may switch to the target cell in operation 427. For example, relay node 401B may perform a random access procedure with the target cell. In response to a successful random access, relay node 401B may transmit a reconfiguration complete message to BS 302B in operation 431.

In response to a successful handover of relay node 401B (e.g., in response to completing the random access, the stop of a handover timer (e.g., T304 as specified in 3GPP specifications), a successful random access, the transmission of the reconfiguration complete message, or the like), relay node 401B may transmit to UE 401A the RRC reconfiguration message for path switch associated with UE 401A in operation 429. In some embodiments, in response to a successful handover of relay node 401B (e.g., in response to completing the random access, a successful random access, the transmission of the reconfiguration complete message, or the like), relay node 401B may transmit an indication indicating the successful handover of relay node 401B to UE 401A.

In operation 433, in response to receiving the RRC reconfiguration message for path switch or the indication indicating the successful handover, UE 401A may apply the RRC reconfiguration message. For example, UE 401A may switch to the target cell (e.g., via relay node 401B). In some embodiments, in response to receiving the RRC reconfiguration message for path switch or the indication indicating the successful handover, UE 401A may stop the timer for the upcoming path switch. In some other embodiments, UE 401A may perform reestablishment in response to the expiry of the timer.

In some embodiments, in response to receiving the RRC reconfiguration message, UE 401A may reestablish its RLC entity when the bearer between UE 401A and relay node 401B is configured to reestablish the RLC entity. In some embodiments, in response to receiving the RRC reconfiguration message, UE 401A may reestablish its PDCP entity when the bearer between UE 401A and relay node 401B is configured to reestablish the PDCP entity.

In operations 435 and 435′, UE 401A may transmit a reconfiguration complete message to BS 402B via relay 401B in response to a successful path switch. In operation 437, BS 402B may transmit to BS 402A a UE context release message for relay node 401B, UE 401A, or both. For example, in response to receiving the reconfiguration complete messages from relay node 401B and UE 401A, BS 402B may indicate to release the UE context of both relay node 401B and UE 401A.

In some other embodiments of the present disclosure, the handover of relay node 401B may fail. Relay node 401B may perform reestablishment in response to the handover failure. In some embodiments, relay node 401B may transmit an indication to UE 401A to indicate the unsuccessful handover or reestablishment. In some embodiments, in response to receiving the indication indicating the unsuccessful handover or reestablishment, UE 401A may stop the timer for the upcoming path switch (if running) and perform reestablishment.

It should be appreciated by persons skilled in the art that the sequence of the operations in exemplary procedure 400 may be changed and that some of the operations in exemplary procedure 400 may be eliminated or modified, without departing from the spirit and scope of the disclosure.

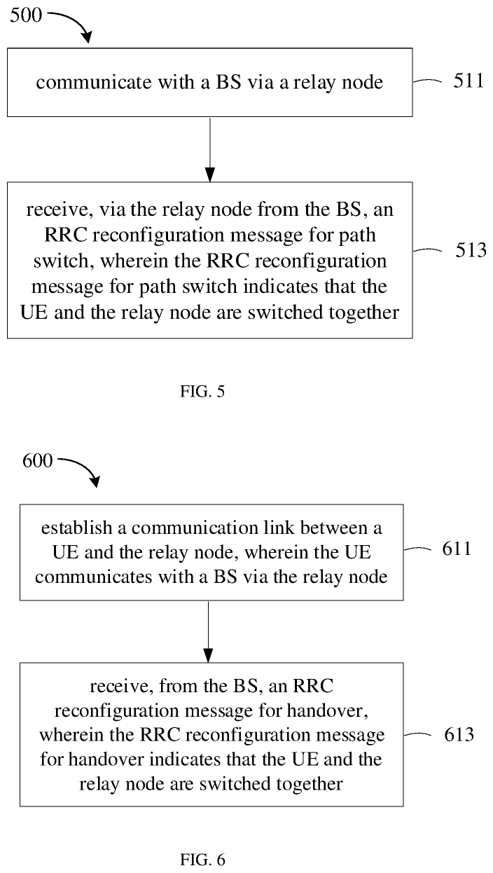

FIG. 5 illustrates a flow chart of exemplary procedure 500 for wireless communications in accordance with some embodiments of the present disclosure. Details described in all of the foregoing embodiments of the present disclosure are applicable for the embodiments shown in FIG. 5. In some examples, the procedure may be performed by a UE.

Referring to FIG. 5, in operation 511, a UE may communicate with a BS via a relay node. In operation 513, the UE may receive, via the relay node from the BS, an RRC reconfiguration message for path switch, wherein the RRC reconfiguration message for path switch may indicate that the UE and the relay node are switched together.

In some embodiments, the RRC reconfiguration message for path switch may indicate the relay node as a target relay node for the path switch. In some embodiments, the RRC reconfiguration message for path switch may indicate an ID of a target relay node for the path switch, which is a source layer-2 ID of the relay node.

In some embodiments, the UE may perform at least one of the following in response to receiving the RRC reconfiguration message for path switch: storing the RRC reconfiguration message for path switch; or starting a timer for group-based path switch. In some embodiments, the UE may perform at least one of the following: stopping transmitting UP data when the timer for group-based path switch is running; receiving a first indication from the relay node and stopping the timer for group-based path switch in response to receiving the first indication, wherein the first indication may indicate a successful handover of the relay node, an unsuccessful handover of the relay node, or reestablishment of the relay node; or performing reestablishment in response to an expiry of the timer for group-based path switch.

In some embodiments, the RRC reconfiguration message for path switch may indicate a value of a timer for group-based path switch.

In some embodiments, the UE may receive a first indication from the relay node, wherein the first indication may indicate a successful handover of the relay node, an unsuccessful handover of the relay node, or reestablishment of the relay node; and apply the RRC reconfiguration message for path switch in response to receiving the first indication.

In some embodiments, the UE may receive, from the relay node, a second indication which may indicate that the path switch is upcoming. The UE may start a timer for the upcoming path switch in response to receiving the second indication. In some embodiments, the second indication may indicate a value of the timer for the upcoming path switch.

In some embodiments, the UE may perform at least one of the following: receiving a third indication from the relay node and stopping the timer for the upcoming path switch in response to receiving the third indication, wherein the third indication may indicate a successful handover of the relay node; stopping the timer for the upcoming path switch in response to receiving the RRC reconfiguration message for path switch; or performing reestablishment in response to an expiry of the timer for the upcoming path switch.

In some embodiments, the UE may apply the RRC reconfiguration message for path switch in response to receiving the RRC reconfiguration message for path switch. In some embodiments, the UE may receive a third indication which may indicate a successful handover of the relay node, and apply the RRC reconfiguration message for path switch in response to receiving the third indication.

In some embodiments, in response to receiving the RRC reconfiguration message for path switch, the UE may perform at least one of: reestablishing a RLC entity of the UE when a bearer between the UE and the relay node is configured to reestablish the RLC entity; or reestablishing a PDCP entity of the UE when the bearer between the UE and the relay node is configured to reestablish the PDCP entity.

It should be appreciated by persons skilled in the art that the sequence of the operations in exemplary procedure 500 may be changed and some of the operations in exemplary procedure 500 may be eliminated or modified, without departing from the spirit and scope of the disclosure.

FIG. 6 illustrates a flow chart of exemplary procedure 600 for wireless communications in accordance with some embodiments of the present disclosure. Details described in all of the foregoing embodiments of the present disclosure are applicable for the embodiments shown in FIG. 6. In some examples, the procedure may be performed by a relay node (e.g., a relay UE).

Referring to FIG. 6, in operation 611, a relay node may establish a communication link (e.g., PC5 link) between a UE and the relay node, wherein the UE communicates with a BS via the relay node. In operation 613, the relay node may receive, from the BS, an RRC reconfiguration message for handover, wherein the RRC reconfiguration message for handover indicates that the UE and the relay node are switched together.

In some embodiments, the RRC reconfiguration message for handover indicates at least one remote UE including the UE. In some embodiments, the RRC reconfiguration message for handover indicates an ID of a remote UE, which is a source layer-2 ID of the UE.

In some embodiments, the relay node may transmit a first indication to the UE in response to a successful handover of the relay node, an unsuccessful handover of the relay node, or reestablishment of the relay node.

In some embodiments, the RRC reconfiguration message for handover encapsulates an RRC reconfiguration message for path switch associated with the UE.

In some embodiments, the relay node may transmit a second indication indicating an upcoming path switch to the UE in response to receiving the RRC reconfiguration message for handover. The second indication indicates a value of a timer for the upcoming path switch.

In some embodiments, the RRC reconfiguration message for handover indicates a value of a timer for an upcoming path switch.

In some embodiments, the relay node may transmit the RRC reconfiguration message for path switch to the UE in response to a successful random access of the relay node. In some embodiments, the relay node may transmit, to the UE, the RRC reconfiguration message for path switch and a third indication which indicates a successful handover of the relay node in response to a successful random access of the relay node.

In some embodiments, the RRC reconfiguration message for path switch indicates that the UE and the relay node are switched together.

In some embodiments, in response to receiving the RRC reconfiguration message for handover, the relay node may perform at least one of: reestablishing a RLC entity of the relay node when a bearer between the UE and the relay node is configured to reestablish the RLC entity; or reestablishing a PDCP entity of the relay node when the bearer between the UE and the relay node is configured to reestablish the PDCP entity.

It should be appreciated by persons skilled in the art that the sequence of the operations in exemplary procedure 600 may be changed and some of the operations in exemplary procedure 600 may be eliminated or modified, without departing from the spirit and scope of the disclosure.

FIG. 7 illustrates a flow chart of exemplary procedure 700 for wireless communications in accordance with some embodiments of the present disclosure. Details described in all of the foregoing embodiments of the present disclosure are applicable for the embodiments shown in FIG. 7. In some examples, the procedure may be performed by a BS.

Referring to FIG. 7, in operation 711, a BS (e.g., target BS) may receive a handover request message from a first BS (e.g., source BS), wherein the handover request message indicates a UE and a relay node are switched together and wherein the UE communicates with the first BS via the relay node. In operation 713, the BS may transmit a handover request acknowledgement message to the first BS in response to the handover request message.

In some embodiments, the handover request acknowledgement message may include an RRC reconfiguration message for path switch associated with the UE, and an RRC reconfiguration message for handover associated with the relay node. The RRC reconfiguration message for path switch associated with the UE and the RRC reconfiguration message for handover associated with the relay node indicate that the UE and the relay node are switched together.

In some embodiments, the RRC reconfiguration message for path switch associated with the UE indicates the relay node as a target relay node for the path switch. The RRC reconfiguration message for handover associated with the relay node indicates at least one remote UE including the UE. In some embodiments, the RRC reconfiguration message for path switch associated with the UE indicates an ID of a target relay node for the path switch, which is a source layer-2 ID of the relay node. The RRC reconfiguration message for handover associated with the relay node indicates an ID of a remote UE, which is a source layer-2 ID of the UE.

In some embodiments, the RRC reconfiguration message for path switch associated with the UE and the RRC reconfiguration message for handover associated with the relay node are independently included in the same handover request acknowledgement message or included in separate handover request acknowledgement messages.

In some embodiments, the RRC reconfiguration message for path switch associated with the UE indicates a value of a timer for group-based path switch.

In some embodiments, the RRC reconfiguration message for path switch associated with the UE is encapsulated in the RRC reconfiguration message for handover associated with the relay node. The RRC reconfiguration message for handover associated with the relay node indicates a value of a timer for an upcoming path switch.

It should be appreciated by persons skilled in the art that the sequence of the operations in exemplary procedure 700 may be changed and some of the operations in exemplary procedure 700 may be eliminated or modified, without departing from the spirit and scope of the disclosure.

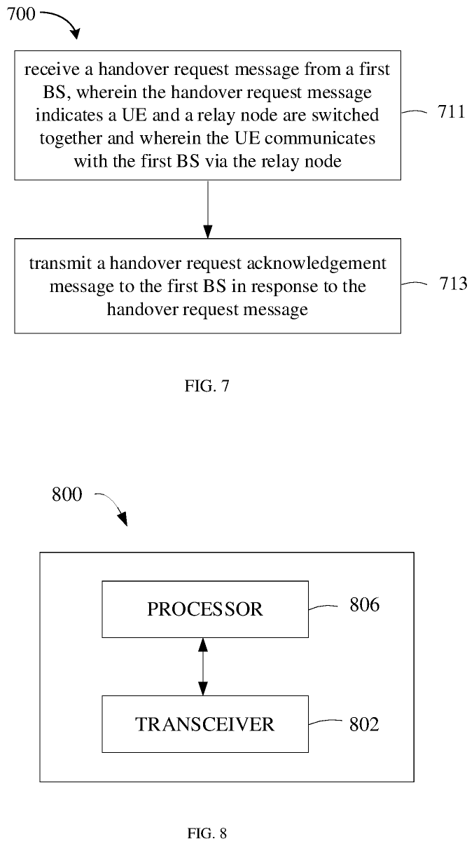

FIG. 8 illustrates a block diagram of exemplary apparatus 800 according to some embodiments of the present disclosure.

As shown in FIG. 8, the apparatus 800 may include at least one processor 806 and at least one transceiver 802 coupled to the processor 806. The apparatus 800 may be a BS, a relay node, or a UE.

Although in this figure, elements such as the at least one transceiver 802 and processor 806 are described in the singular, the plural is contemplated unless a limitation to the singular is explicitly stated. In some embodiments of the present application, the transceiver 802 may be divided into two devices, such as a receiving circuitry and a transmitting circuitry. In some embodiments of the present application, the apparatus 800 may further include an input device, a memory, and/or other components.

In some embodiments of the present application, the apparatus 800 may be a UE. The transceiver 802 and the processor 806 may interact with each other so as to perform the operations with respect to the UEs described in FIGS. 1-7. In some embodiments of the present application, the apparatus 800 may be a relay node. The transceiver 802 and the processor 806 may interact with each other so as to perform the operations with respect to the relay nodes described in FIGS. 1-7. In some embodiments of the present application, the apparatus 800 may be a BS. The transceiver 802 and the processor 806 may interact with each other so as to perform the operations with respect to the BSs described in FIGS. 1-7.

In some embodiments of the present application, the apparatus 800 may further include at least one non-transitory computer-readable medium.

For example, in some embodiments of the present disclosure, the non-transitory computer-readable medium may have stored thereon computer-executable instructions to cause the processor 806 to implement the method with respect to the UEs as described above. For example, the computer-executable instructions, when executed, cause the processor 806 interacting with transceiver 802 to perform the operations with respect to the UEs described in FIGS. 1-7.

In some embodiments of the present disclosure, the non-transitory computer-readable medium may have stored thereon computer-executable instructions to cause the processor 806 to implement the method with respect to the relay nodes as described above. For example, the computer-executable instructions, when executed, cause the processor 806 interacting with transceiver 802 to perform the operations with respect to the relay nodes described in FIGS. 1-7.

In some embodiments of the present disclosure, the non-transitory computer-readable medium may have stored thereon computer-executable instructions to cause the processor 806 to implement the method with respect to the BSs as described above. For example, the computer-executable instructions, when executed, cause the processor 806 interacting with transceiver 802 to perform the operations with respect to the BSs described in FIGS. 1-7.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “handover” and “path switch” may be used interchangeably. The terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE), comprising:
at least one memory; and
at least one processor coupled with the at least one memory and configured to cause the UE to:
communicate with a base station via a relay node; and
receive, via the relay node from the base station, a radio resource control (RRC) reconfiguration message for path switch, wherein the RRC reconfiguration message for path switch indicates that the UE and the relay node are switched together.

2. The UE of claim 1, wherein the RRC reconfiguration message for path switch indicates the relay node as a target relay node for the path switch.

3. The UE of claim 1, wherein the RRC reconfiguration message for path switch indicates an ID of a target relay node for the path switch, which is a source layer-2 ID of the relay node.

4. The UE of claim 1, wherein the at least one processor is configured to cause the UE to perform at least one of the following in response to receiving the RRC reconfiguration message for path switch:
store the RRC reconfiguration message for path switch; or
start a timer for group-based path switch.

5. The UE of claim 4, wherein the at least one processor is configured to cause the UE to perform at least one of the following:
stop transmitting user plane (UP) data when the timer for group-based path switch is running;
receive a first indication from the relay node and stopping the timer for group-based path switch in response to receiving the first indication, wherein the first indication indicates a successful handover of the relay node, an unsuccessful handover of the relay node, or reestablishment of the relay node; or
perform reestablishment in response to an expiry of the timer for group-based path switch.

6. The UE of claim 1, wherein the RRC reconfiguration message for path switch indicates a value of a timer for group-based path switch.

7. The UE of claim 1, wherein the at least one processor is configured to cause the UE to:
receive a first indication from the relay node, wherein the first indication indicates a successful handover of the relay node, an unsuccessful handover of the relay node, or reestablishment of the relay node; and
apply the RRC reconfiguration message for path switch in response to receiving the first indication.

8. The UE of claim 1, wherein the at least one processor is configured to cause the UE to receive, from the relay node, a second indication which indicates that the path switch is upcoming.

9. The UE of claim 8, wherein the at least one processor is configured to cause the UE to start a timer for the upcoming path switch in response to receiving the second indication.

10. The UE of claim 9, wherein the second indication indicates a value of the timer for the upcoming path switch.

11. The UE of claim 9, wherein the at least one processor is configured to cause the UE to perform at least one of the following:
receive a third indication from the relay node and stopping the timer for the upcoming path switch in response to receiving the third indication, wherein the third indication indicates a successful handover of the relay node;
stop the timer for the upcoming path switch in response to receiving the RRC reconfiguration message for path switch; or
perform reestablishment in response to an expiry of the timer for the upcoming path switch.

12. The UE of claim 8, wherein the at least one processor is configured to cause the UE to apply the RRC reconfiguration message for path switch in response to receiving the RRC reconfiguration message for path switch; or
wherein the at least one processor is configured to cause the UE to receive a third indication which indicates a successful handover of the relay node, and apply the RRC reconfiguration message for path switch in response to receiving the third indication.

13. The UE of claim 1, wherein in response to receiving the RRC reconfiguration message for path switch, the at least one processor is configured to cause the UE to perform at least one of:
reestablish a radio link control (RLC) entity of the UE when a bearer between the UE and the relay node is configured to reestablish the RLC entity; or
reestablish a packet data convergence protocol (PDCP) entity of the UE when the bearer between the UE and the relay node is configured to reestablish the PDCP entity.

14. A relay node, comprising:
at least one memory; and
at least one processor coupled with the at least one memory and configured to cause the relay node to:
establish a communication link between a user equipment (UE) and the relay node, wherein the UE communicates with a base station via the relay node; and
receive, from the base station, a radio resource control (RRC) reconfiguration message for handover, wherein the RRC reconfiguration message for handover indicates that the UE and the relay node are switched together.

15. A base station, comprising:
at least one memory; and
at least one processor coupled with the at least one memory and configured to cause the base station to:
receive a handover request message from a first base station, wherein the handover request message indicates a user equipment (UE) and a relay node are switched together and wherein the UE communicates with the first base station via the relay node; and
transmit a handover request acknowledgement message to the first base station in response to the handover request message.

16. The base station of claim 15, wherein the handover request acknowledgement message comprises a radio resource control (RRC) reconfiguration message for path switch associated with the UE, and an RRC reconfiguration message for handover associated with the relay node; and
wherein the RRC reconfiguration message for path switch associated with the UE and the RRC reconfiguration message for handover associated with the relay node indicate that the UE and the relay node are switched together.

17. The base station of claim 15, wherein the RRC reconfiguration message for path switch associated with the UE indicates the relay node as a target relay node for the path switch; and wherein the RRC reconfiguration message for handover associated with the relay node indicates at least one remote UE including the UE.

18. The base station of claim 15, wherein the RRC reconfiguration message for path switch associated with the UE indicates an ID of a target relay node for the path switch, which is a source layer-2 ID of the relay node; and
wherein the RRC reconfiguration message for handover associated with the relay node indicates an ID of a remote UE, which is a source layer-2 ID of the UE.

19. The base station of claim 15, wherein the RRC reconfiguration message for path switch associated with the UE and the RRC reconfiguration message for handover associated with the relay node are independently included in the same handover request acknowledgement message or included in separate handover request acknowledgement messages.

20. A processor for wireless communication, comprising:
at least one controller coupled with at least one memory and configured to cause the processor to:
communicate with a base station via a relay node; and
receive, via the relay node from the base station, a radio resource control (RRC) reconfiguration message for path switch, wherein the RRC reconfiguration message for path switch indicates that the UE and the relay node are switched together.
